(19) United States
(12) Patent Application Publication
(10) Pub. No.: US 2003/0187673 A1
(43) Pub. Date: Oct. 2, 2003

(54) Distributed click-to-print

(75) Inventors: Bradford H. Needham, North Plains, OR (US); Mark Lewis, La Grande, OR (US); John A. Throckmorton, Lake Oswego, OR (US); Dan D. Kogan, Portland, OR (US)

Correspondence Address: Pillsbury Winthrop LLP, Intellectual Property Group, Suite 2800, 725 So. Figueroa Street, Los Angeles, CA, 90017-5406, US

(73) Assignee: INTEL CORPORATION

(21) Appl. No.: 10/113,478

(22) Filed: Mar. 29, 2002

(51) Int. Cl. G06F 17/60

(52) U.S. Cl. 705/1

(57) ABSTRACT

A distributed click-to-print system is disclosed. Components of the system include a personal photo management system, which typically resides on an amateur photographer's computer, a messaging system that supports simple message automation, a client message browsing system, and a photo merchandising system, which is accessible from a data communication network. The system automates the previously manual step of uploading photos, eliminates the cost and time of uploading photos that are not used in producing photo-related merchandise, eliminates the storing of unrequested photos on a merchandiser's website, and enables a photographer's acquaintance to order prints long after such photos may been purged from the merchandiser's service. That is, the system relies on the photographer's personal photo collection for long-term storage and further changes print ordering from a push model to a pull model, in which the photo merchandise service downloads only photos that have been requested.

### BACKGROUND

1. Field of the Invention

Embodiments described herein are directed to a distributed click-to-print photograph system. Specifically, a personal photo management system, a messaging system, a client message browsing system, and a photo merchandising system interact to provide a cost-effective and efficient way for users to share photo prints.

2. Related Art

For many years, small businesses have provided prints, posters, mugs, t-shirts, and other merchandise based on film photographs. That is, a customer sends a photograph along with an order, and the companies produce the desired merchandise. Similar businesses based on digital photographs have, however, suffered from the disadvantage that they have been primarily coupled to web-based photo sharing sites. The cost of long-term photo storage at such sites has, in most cases, proven too expensive to sustain the businesses.

Current digital photo merchandising systems require that the photographer upload manually to the merchandising service all photographs of which someone may potentially order prints. They also require that the photo merchandiser retain copies of all those photos for a long period of time, in the event that someone wishes to order a print after much time has lapsed. Online photo sharing sites offer the ability to order prints by clicking on a picture stored on the site. Peer-to-peer photo sharing systems exist, but they do not provide the ability to order prints or other merchandise.

As such, a distributed click-to-print solution to the above-outlined shortcomings that would enable businesses to offer digital-media-based merchandise at a low cost by storing only those photos that are required to produce the merchandise would prove beneficial.

### BRIEF DESCRIPTION OF THE DRAWINGS

A detailed description of embodiments of the invention will be made with reference to the accompanying drawings, wherein like numerals designate corresponding parts in the several figures.

FIG. 1 is a block diagram of the components and flow of a distributed click-to-print system, according to an embodiment of the present invention.

FIG. 2 is a flow chart of the steps involved in a distributed click-to-print system, according to an embodiment of the invention.

### DETAILED DESCRIPTION

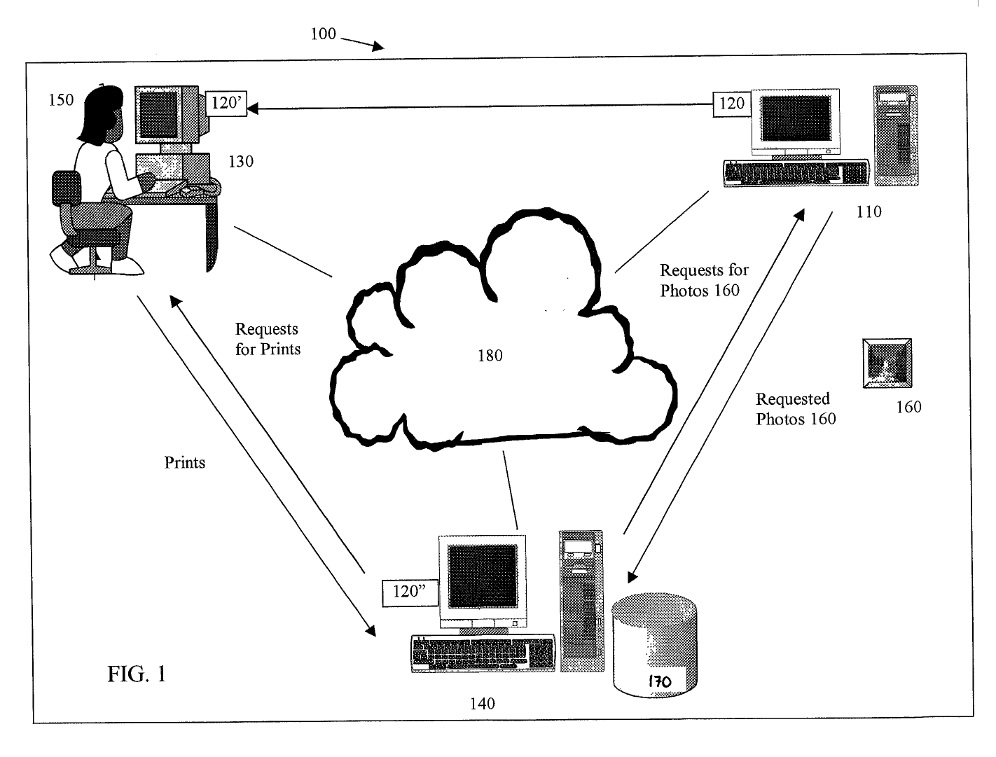

The following paragraphs describe a distributed click-to-print photo system 100. FIG. 1 shows an example of the main components and flow of the distributed click-to-print photo system 100. The main components of the distributed click-to-print photo system 100 include a personal photo management system 110, a messaging system 120, a client message browsing system 130, and a photo merchandising service 140.

The personal photo management system 110 typically resides on an amateur photographer's computer. The computer may be a desktop computer, notebook computer, personal digital assistant, cell phone, gaming device or other handheld device, or any other suitable computing device. The messaging system 120, such as for example HyperText Markup Language (“HTML”) electronic mail or a custom messaging system and protocol, supports message automation. The client message browsing system 130 is typically part of a personal computer or handheld communication device belonging to an acquaintance 150 of the photographer. The photo merchandising system 140 is accessible by the photo management system 110 and the client message browsing system 130 from a data communication network 180.

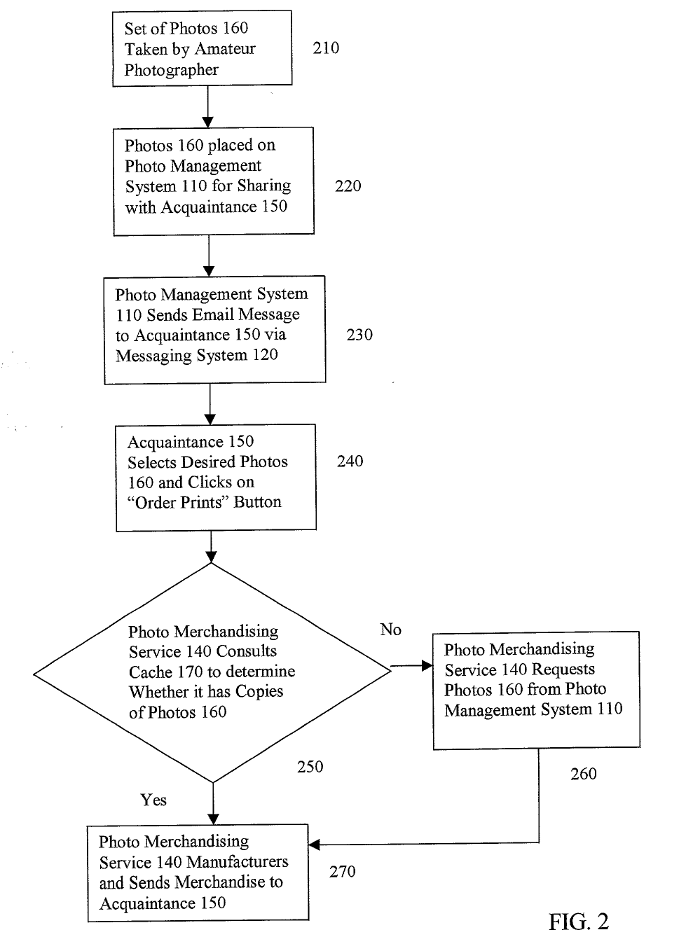

FIG. 2 is a flowchart of the steps involved in a preferred embodiment of a distributed click-to-print system 100. As shown in step 210 of FIG. 2, the interaction begins with an amateur photographer taking a set of photographs 160 (“photos”). Photos 160 may include, for example, original digital photographs, original film photographs converted into digital photographs via scanning or another appropriate method, digital video clips from which digital photographs are extracted, and images from any source that are converted into a digital format for transmission.

The photographer then places the photos 160 in his or her personal photo management system 110 and requests that the personal photo management system 110 share the photos 160 with an acquaintance 150, as illustrated in step 220. As a result, as depicted in step 230, the personal photo management system 110 sends a formatted electronic mail message to the acquaintance 150 via a messaging system 120.

The electronic mail message that the photo management system 110 sends is generally an HTML message that contains thumbnails of the shared photos 160, checkboxes next to each thumbnail, and an “order prints” button. Collateral, in the form of descriptions and warranties, for instance, may accompany the photos 160. The electronic mail message sent from the photo management system 110 may simply be a textual description of the photos 160.

The Uniform Resource Locator (“URL”) to be activated by the “order prints” button is directed to the photo merchandising service 140 and will cause the browser to send an HTML form response to the photo merchandising service 140 that contains the information necessary to contact the photographer's personal photo management system 110, to identify the desired photos 160 on the personal photo management system 110, and to authorize the photo merchandising service 140 to request the photos 160.

Upon receiving the electronic mail message, as shown in step 240, the photographer's acquaintance 150 clicks on the desired photos 160, and then clicks on the “order prints” button. The client message browsing system 130 is employed for these activities. Upon receipt of the HTML form response, the photo merchandising service 140 presents the normal set of web pages to the photographer's acquaintance 150 to enable the acquaintance 150 to describe details such as method of payment and desired merchandise such as but not limited to calendars, mugs, posters, and shirts.

Once the acquaintance 150 orders the merchandise, the photo merchandising service 140 consults its cache 170, as illustrated in step 250, to determine whether it already has copies of the desired photos 160. If the photo merchandising service 140 does not have copies of such photos 160, the photo merchandising service 140 contacts the photographer's personal photo management system 110 via a messaging system 120 and requests high-resolution copies of the necessary photos 160, as shown in step 260. An embodiment for alternative access to photos 160 includes posting the photos 160 on a website maintained by the photographer and accessible by a unique password or other secure measure to prevent unauthorized users from gaining access to photos 160.

As depicted in step 270, upon receipt of the high-resolution copies of the photos 160, the photo merchandising service 140 stores the photos 160 in its cache 170 and then manufactures and sends the desired merchandise to the photographer's acquaintance 150. As an option, the photographer's photo management system 110 may reject requests for copies of photos 160 from anyone who or any entity that is unknown to the photographer.

The removing of photo storage from the photo merchandising service 140, while relying on the photographer's personal photo collection for long-term storage allows for a cost-effective and efficient way for photo 160 sharing. Moreover, the altering of the manner of print ordering from a push model whereby the photographer uploads all photos 160 that may be ordered to a pull model in which the photo merchandising service 140 downloads only the photos that are requested further provides advantages over current systems.

In summary, the distributed click-to-print system 100 automates the previously manual step of uploading photos 160, eliminates the cost and time of uploading photos 160 that are not used in producing photo-related merchandise, eliminates the storing of unrequested photos 160 on a merchandiser's website, and enables a photographer's acquaintance 150 to order prints long after such photos 160 may been purged from the merchandiser's service.

While the above description refers to particular embodiments of the present invention, it will be understood to those of ordinary skill in the art that modifications may be made without departing from the spirit thereof The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

What is claimed is:

1. A computerized photo system, comprising:
a first, second, and third computing device, each adapted for coupling to a data communication network; and
an electronic messaging system adapted for sending and receiving electronic messages over said network between the first, second, and third computing devices, wherein the photo system functions to:
store at least one photo at the first computing device;
send an electronic message over said network from the first computing device to the second computing device with a representation of the at least one photo and information identifying the third computing device sufficient to enable the second computing device to send an electronic message over said network to the third computing device;
send an electronic message over said network from the second computing device to the third computing device, requesting photo merchandise comprising the at least one photo on a piece of merchandise to be created and sent to a recipient at a particular location;
send the at least one photo over the from the first computing device to the third computing device either before or after the third computing device receives the electronic message from the second computing device requesting the photo merchandise;
the third computing device accessing the photo for use in creating the photo merchandise for sending to the recipient at the particular location.

2. The system of claim 1, wherein the data communication network includes at least one of the Internet and an Intranet.

3. The system of claim 1, wherein the third computing device rejects requests for the at least one photo from an unknown user.

4. The system of claim 1, wherein the first computing device receives a request for the at least one photo over the data communications network from the third computing device before the at least one photo is sent from the first computing device to the third computing device but after the third computing device receives the electronic message from the second computing device requesting the photo merchandise.

5. The system of claim 4, wherein the first computing device rejects requests for the at least one photo from an unknown user.

6. The system of claim 1, wherein in addition to the photo, collateral is sent over the data communications network from the first computing device to the third computing device to the second computing device.

7. The system of claim 1, wherein the representation of the at least one photo is a textual description of the at least one photo.

8. The system of claim 1, wherein the representation of the at least one photo is a thumbnail image of the at least one photo.

9. The system of claim 1, wherein the third computing device includes a storage system and determines if the at least one photo is in its storage system after receiving the request photo merchandise request from the second computing device.

10. The system of claim 6, wherein the third computing device sends an electronic message to the first computing device requesting a copy of the at least one photo, if the third computing device determines that it does not have the at least one photo in its storage system.

11. A method of photo merchandising using a data communication network, comprising:
placing a plurality of photos on a first computing device;
transmitting over said network, from the first computing device to a second computing device, a depiction of the one or more photos selected from the plurality of photos;
selecting at the second computing device at least one photo from the depiction of the one or more photos received by the second computing device;
transmitting over said network, from the second computing device to a third computing device, an order request for photo merchandise comprising the at least one selected photo on a piece of merchandise to be created and sent to a recipient at a particular location;
consulting a storage associated with the third computing device to determine if the at least one selected photo is stored in the storage;
transmitting over said network, from the third computing device to the first computing device, a request for the at least one selected photo if the third computing device does not have the at least one selected photo in its associated storage, and then forwarding the at least one selected photo from the first computing device to the third computing device and then storing the at least one selected photo in the storage associated with the third computing device; and
accessing the at least one selected photo from the storage associated with the third computing device and then filling the order request for the photo merchandise.

12. The method of claim 11, wherein the one or more photos are made available only to authorized purchasers.

13. The method of claim 11, wherein the electronic message with the depiction of the one or more photos further includes a checkbox next to each of the one or more photos and an order prints button.

14. The method of claim 11, wherein the data communication network includes at least one of the Internet and an Intranet.

15. The method of claim 11, wherein the photo merchandise includes at least one of posters, calendars, mugs, writing instruments, and apparel.

16. The method of claim 11, wherein an HTML document is provided by the first computing device to the second computing device.

17. The method of claim 11, wherein a mouse button is clicked when a cursor is positioned over a predefined area of the depiction of the one or more photos received by the second computing device.

18. The method of claim 11, wherein partial payment information is displayed on the order request for the photo merchandise.

19. The method of claim 11, wherein partial shipping information is displayed on the order request for the photo merchandise.

20. The method of claim 11, wherein payment is remitted to the third computing device from the second computing device.

21. A system for photo merchandising using a data communication network comprising a computer readable medium and a computer readable program code stored on the computer readable medium having instructions to:
receive over the data communication network an order for a photo merchandise comprising at least one photo on a piece of merchandise to be created and sent to a customer;
send over the data communication network a request for a copy of the at least one photo to a node on the data communication network;
receive the at least one photo over the data communication network; and
process the order for the photo merchandise to be shipped to the customer.

22. The system of claim 21, wherein the data communication network includes at least one of the Internet and an Intranet.

23. The system of claim 21, wherein the photo merchandise includes at least one of posters, calendars, mugs, writing implements, and clothing.
